(19) United States
(12) Patent Application Publication
(10) Pub. No.: US 2014/0290469 A1
(43) Pub. Date: Oct. 2, 2014

(54) Audio Effect Control Pedal

(71) Applicants: Scott Ray Michaud, Rutherglen (CA); Ryan Albert Marcel Michaud, Rutherglen (FR)

(72) Inventors: Scott Ray Michaud, Rutherglen (CA); Ryan Albert Marcel Michaud, Rutherglen (FR)

(21) Appl. No.: 13/854,527

(22) Filed: Apr. 1, 2013

(51) Int. Cl. G10H 1/02

(52) U.S. Cl. CPC G10H 1/02
USPC 84/741; 84/737

(57) ABSTRACT

An audio effect control pedal for musicians has, in one embodiment, a first input connection (30), a second input connection (36), a first output connection (38), a second output connection (34), and a mixing circuit (32). The mixing circuit inputs are connected to the first (30) and second (36) input connections, and the output of the mixing circuit is connected to the first output connection (38). The mixing circuit creates an output signal that is a combination of the signals present on the first and second input connections. A treadle (46) is mechanically linked to a potentiometer (P1) that is part of the mixing circuit. Moving the treadle rotates the potentiometer and changes the proportion of signals from the first and second input connections. Other embodiments are described and shown.

### CROSS-REFERENCE TO RELATED APPLICATIONS

This application claims the benefit of provisional patent application Ser. No. 61,619,023 filed 2012 Apr. 2 by the present inventors.

### FEDERALLY SPONSORED RESEARCH

None.

### SEQUENCE LISTING

None.

### BACKGROUND

### Prior Art

The following is a tabulation of some prior art that presently appears relevant:

U.S. Patents

| Patent Number | Kind Code | Issue Date | Patentee |
|---|---|---|---|
| 3,553,338 | B1 | 1971-01-05 | Holman |
| 4,405,832 | B1 | 1983-09-20 | Sondermeyer |
| 4,644,289 | B1 | 1987-02-17 | Kennedy |
| 2,866,849 | B1 | 1958-12-30 | Lindridge |
| 4,150,253 | B1 | 1979-04-17 | Knoppel |
| 3,973,461 | B1 | 1976-08-10 | Jahns |
| 3,530,224 | B1 | 1970-09-22 | Plunkett |
| 5,274,710 | B1 | 1993-12-28 | Shaffer |
| 2,986,953 | B1 | 1961-06-06 | De Armond |
| 4,649,785 | B1 | 1987-03-17 | Chapman |
| 5,981,862 | B1 | 1999-11-09 | Geier |
| 5,977,474 | B1 | 1999-11-02 | O'Brien |
| 7,675,399 | B2 | 2010-03-09 | Ebrey |
| 7,709,726 | B2 | 2010-05-04 | Smith |

### Other Publications

http://www.morleypedals.com/fxb.pdf “FX Blender” Schematic.
http://www.morleypedals.com/fxbman.pdf

Musicians have long wanted to add effects to their music. Desired effects include modifying pitch, timbre, echo, reverb, or another audio property. Several electronic amplifiers, circuits, and effect pedals have been developed to accomplish these effects. Examples of previous patents include the above patent to Holman, which describes a circuit that adds fuzz, tremolo, or reverb effect; the above patent to Sondermeyer, which describes a circuit for distorting an audio signal; the above patent to Kennedy et al., which describes a variable power amplifier that controls the amount of distortion created and has a variable damping knob. In addition to these patented examples, there exists on the market today a plethora of different effects, such as distortion, reverb, tremolo, etc. Effect circuits can be present either in the instrument itself, in a rack-mount unit, in an amplifier, or in an effect pedal. An effect pedal is also referred to as a ‘stompbox’ or simply a ‘pedal’. These effect pedals typically have an input jack that receives signals from an instrument, and an output jack that connects to an amplifier.

Generally, different effect pedals can be connected in series to create an ‘effect chain’. Before a signal is passed through an effect pedal, the instrument creates what is referred to as a “clean” or “dry” signal. Once the signal is modified by an effect device the signal is referred to as being “distorted”, “effected”, or “wet”. Each unit in the effect chain changes the signal in a in a different way. The last pedal of the effect chain sends a final signal to the amplifier so that it can be transformed into an audible sound. Generally, effect pedals have a foot-activated “Effect ON/Bypass” switch that allows the user to decide whether they want the pedal to impart its effect on the signal or not. The problem is that the user often wants to vary the amount of effect present without turning the effect completely ON or OFF. Numerous attempts have been made to give the user control over their effect. These include several different types:

A. Devices that provide parameter modification by means of a potentiometer. These circuits may be stand-alone circuits, they may be integrated in an amplifier, or they may be integrated in an effect pedal:

Sondermeyer, supra, shows a distortion circuit with a potentiometer to adjust the frequency response.

Kennedy et. al., supra, show a variable power amplifier that creates distortion and has a variable damping knob.

There is a very wide range of commercial effect pedals such as the one sold under the trademark BIG MUFF by Electro-Harmonix, or EVH FLANGER by MXR. These pedals typically have an “Effect ON/Bypass” switch as well as control knobs to control various parameters of the effect. Although these devices allow the user to control the effect by varying the control knobs, they are not practical when a musician wants to vary the effect while playing. The musician's hands are usually occupied (as in guitar playing, for example) and cannot be used to manipulate control knobs at the same time.

B. Circuits that split the original signal into two channels; one channel is processed, the other channel is not. The resulting two channels are combined back together to produce the final output signal.

Lindridge, supra, shows an apparatus for improving sounds.

Knoppel, supra, shows a signal distortion circuit.

Jahns, supra, shows a distortion control circuit.

Although these devices provide mixing of processed and non-processed versions of the input signal, no hands-free way of controlling the proportion of these signals is possible. Furthermore, the effect produced is specific to these particular devices, therefore a user could not use these devices to control effect pedals that they already own or that already exist on the market.

Morley Pedals of Cary, Ill., has commercialized a pedal under the trademark FX BLENDER. An effects chain can be hooked up to this pedal by its “send” and “return” jacks. A foot treadle is used to variably attenuate the return signal. The disadvantage of this device is that it does not genuinely mix the clean and the effects channels—it merely attenuates the effects channel that is coming back from the effects chain. Therefore, if no connection is made to the return jack, this pedal does not vary of the amplitude of the input signal. This prevents the device from being used as a volume pedal, which reduces its versatility.

C. Devices that have a foot pedal that controls certain signal properties:

Plunkett, supra, shows a variable frequency preference circuit that is varied by a foot-controlled pedal. This device is commercially known under the trademark WAH-WAH.

Shaffer, supra, shows a pedal volume control.

De Armond et al., supra, show a dual directional volume and tone control pedal.

Chapman, supra, shows a foot pedal that modifies the timbre of a signal.

Geier, supra, shows an effect pedal with a foot-rotatable knob.

Although these devices do provide hands free control, they are limited to controlling the specific effect that is proper to the device itself. A user would not be able to use these devices to vary the amount of effect that is present from a pedal they already own or that is currently available on the market.

O'Brien, supra, describes an amplifier circuit to which an external panning pedal can be connected to produce continuously variable amounts of clean and distorted signal proportions. This device is built into the amplifier itself and is not portable.

Ernie Ball Inc., of California, produces a volume/pan pedal under the trademark ERNIE BALL 6165. The device has two output channels, and the rocking foot pedal allows the user to pan an audio signal from one output channel to another. As in O'Brien's device, this panning pedal can be used to pan a signal between two different input channels on an amplifier—one of which is clean, and the other which is distorted. This allows a variable amount of distortion to be created. As in O'Brien's case however, this device has the cumbersome requirement of a specialized amplifier that has two input channels.

D. Devices that give the user mechanical foot control over the knobs of their pedals:

Ebrey, supra, shows a flexible elongated coupler that allows the user to control a pedal knob from an elevated position.

Smith, supra, shows a large V-shaped lever that attaches to a knob on an effect pedal. It allows the knob to be turned when the user nudges the lever with their foot.

Electro-Harmonix, a company of New York, N.Y., previously manufactured a product under the trademark HOTFOOT UNIVERSAL PEDAL. This device had a foot treadle mechanism that rotated a flexible rotation cable. The flexible cable could be connected to a knob on another pedal. The knob could then be turned by rocking the treadle back and forth. Another company—Tone in Progress, of Santa Rosa, Calif.—is currently manufacturing a similar device under the trademark 3RD HAND. The mechanical connection that is required between these devices and the effect pedal make them awkward to set up. The devices' limited length rotation cable requires that the device be restrictively close to the effect pedal. Furthermore, these devices have trouble rotating knobs of certain pedals which are more difficult to turn.

Furthermore, the HOTFOOT and the 3RD HAND, as well as the above mechanical control devices, are not suitable for certain effects, such as distortion. In distortion pedals, when one decreases the distortion knob, the overall amplitude of the signal is also reduced. For these pedals, a second knob—the master volume—must be adjusted in the opposite sense of the distortion knob in order to maintain constant output amplitude. Since these devices control one knob at a time, they cannot provide constant-gain control of distortion pedals.

E. Digital effect pedals, or ‘multi-effect pedals’, or ‘multi-effect processors’, or ‘multi-FX devices’:

There exist several makes and models of such devices, including a product made by Boss under the trademark ME-25 or by Vox under the trademark TONELAB EX. These devices are made up of digital microprocessor circuits that can be configured to produce several different types of effects. They often include a treadle (or ‘expression pedal’) that can be assigned to various effect parameters. Although such devices provide hands-free control of the effect, such digital circuits are complex and expensive to produce. Furthermore, such devices do not give a user control over other effect pedals that they already own.

In summary, musicians often want to vary the amount of effect that is present in their sound. While several effect devices have been provided, they are limited to varying the built-in effect of the device itself, are not portable, or cannot be used as volume pedals.

### Advantages

Accordingly, several advantages of one or more aspects are to provide (a) a method and means for allowing the amount of effect from an external effect device or effect chain to be continuously varied without the user's hands and while maintaining substantively constant overall gain, (b) means of controlling the amount of effect from an external effect device without the use of a multi-input amplifier (c) a volume controlling device, (d) a mixer for combining two distinct audio signals in a continuously variable proportion, and (e) a means of controlling the amount of effect from different subgroups of an effect chain. Still further objects and advantages will become apparent from a study of the following description and the accompanying drawings.

### SUMMARY

In accordance with one embodiment, a variable effect pedal comprises a foot treadle, a mixing circuit, a first input connection, a second input connection, a first output connection and a second output connection. The first input connection receives a signal which is sent out directly on the second output connection. An external effect circuit receives the signal from the second output connection, processes it, and sends it back to the pedal via the second input connection. Depending on the angular position of the foot treadle, the mixing circuit varies the relative magnitude of signals from the first and second input connections. The output of the mixing circuit is connected to the first output connection. Since certain effect chains phase-shift the signal by 180 degrees, a phase-inverting circuit can be included and selectively activated so that the clean and distorted signals are in phase. This tends to reduce anti-phase cancellation in the mixing of the signals.

Hence, a user can control the amount of effect that is present in their audio signal without the use of their hands. If no external effect is connected to the second output and second input connections, the pedal acts as a volume pedal. In this case, a toggle button may be used to invert the direction of volume increase of the pedal. Another use of the pedal is a mixer: if the second output connection is not connected, and an arbitrary audio signal is connected to the second input connection, the pedal will mix the signal on the first and second input connections.

### DRAWINGS

### Figures

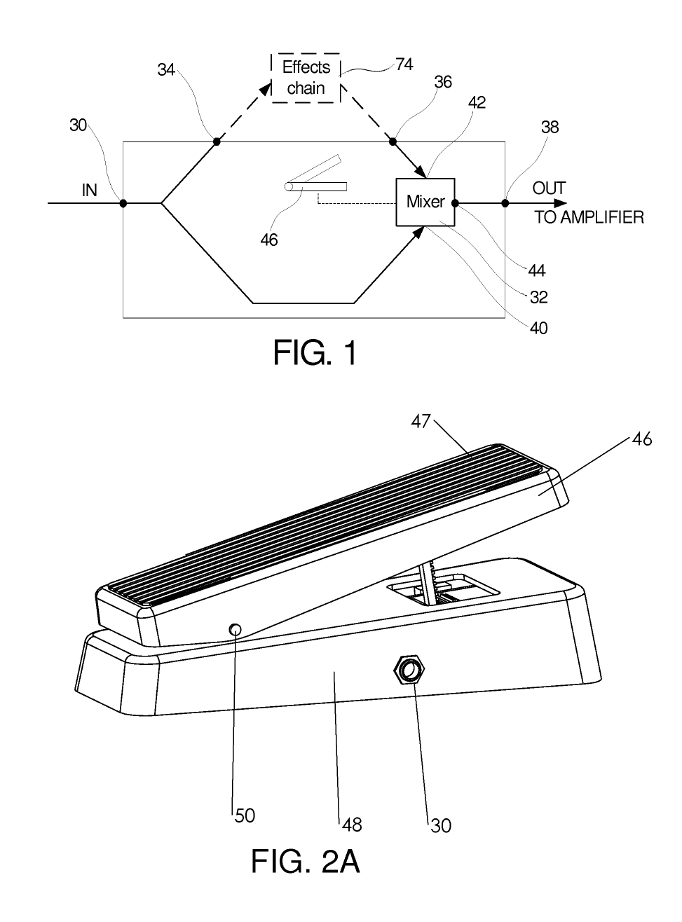

FIG. 1 is a block diagram of a first embodiment of an audio effect control pedal.

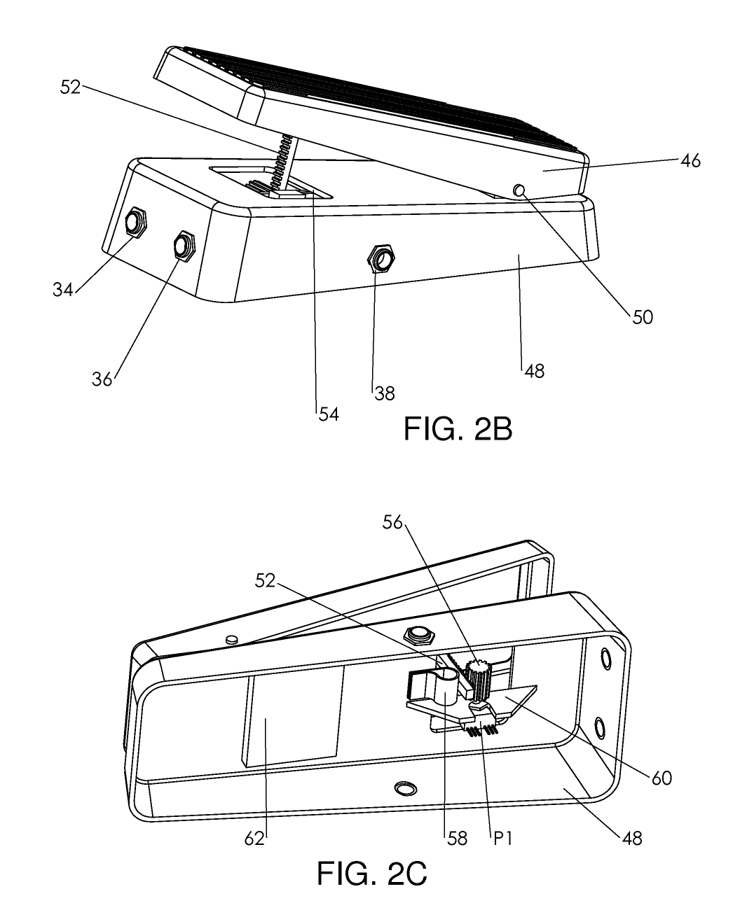

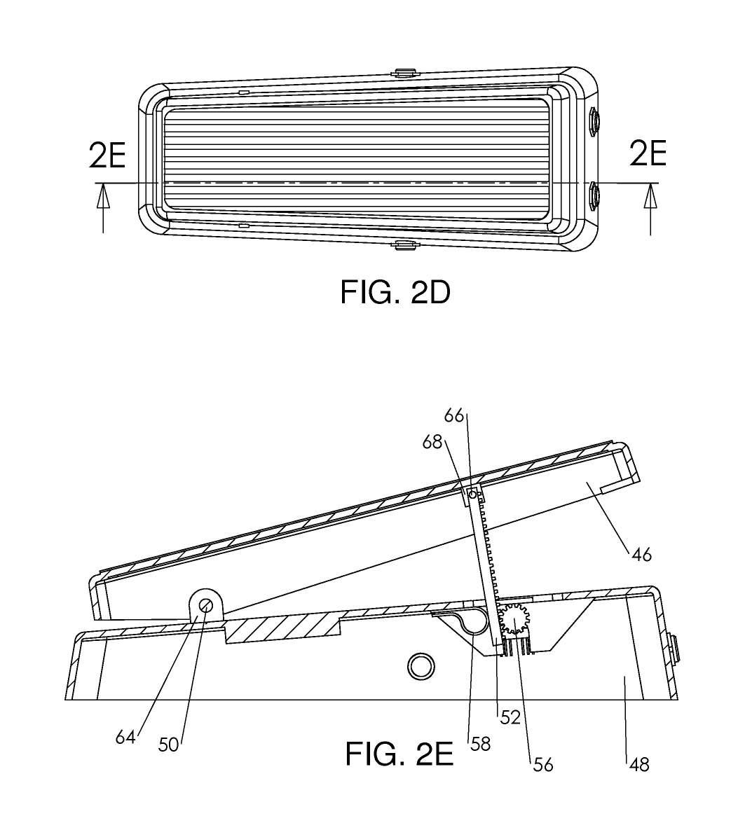

FIGS. 2A, 2B, 2C, 2D, and 2E are mechanical views of the construction of the first embodiment.

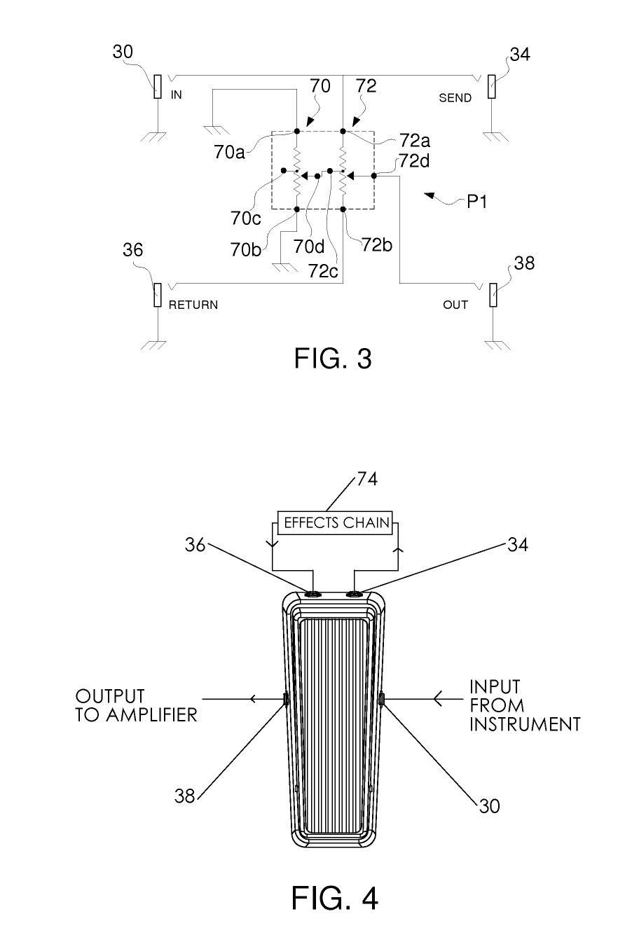

FIG. 3 is an electrical schematic of the first embodiment.

FIGS. 4, 5A, 5B, 6A, 6B, and 7 show the pedal in different modes of operation.

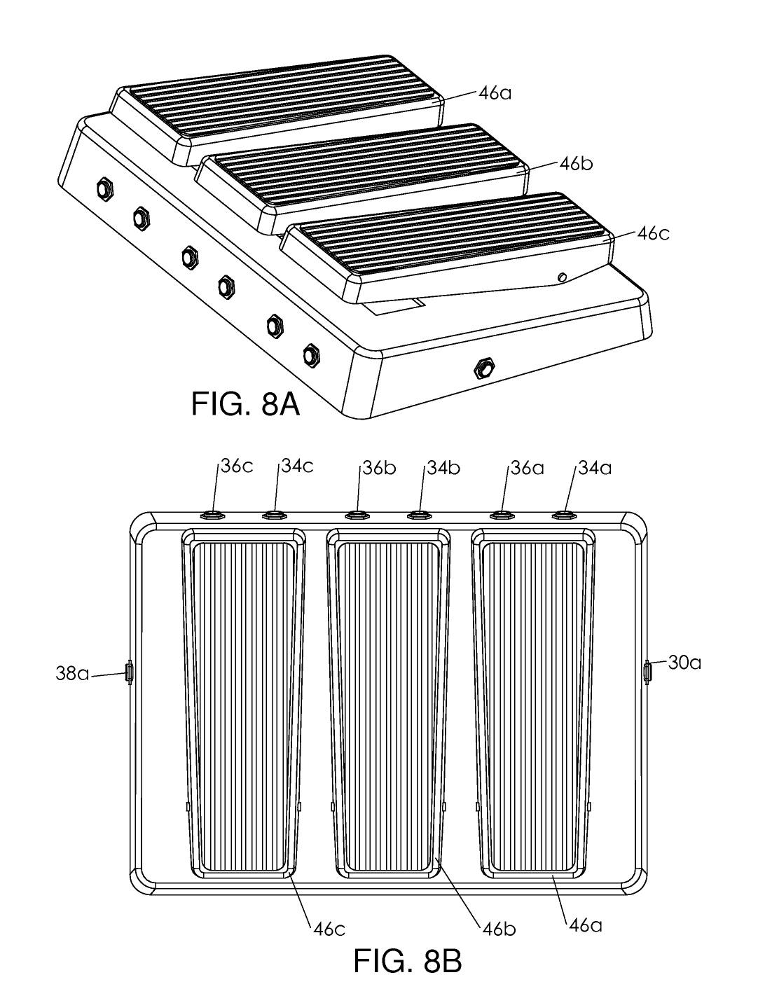

FIGS. 8A and 8B show an alternative embodiment with several treadles.

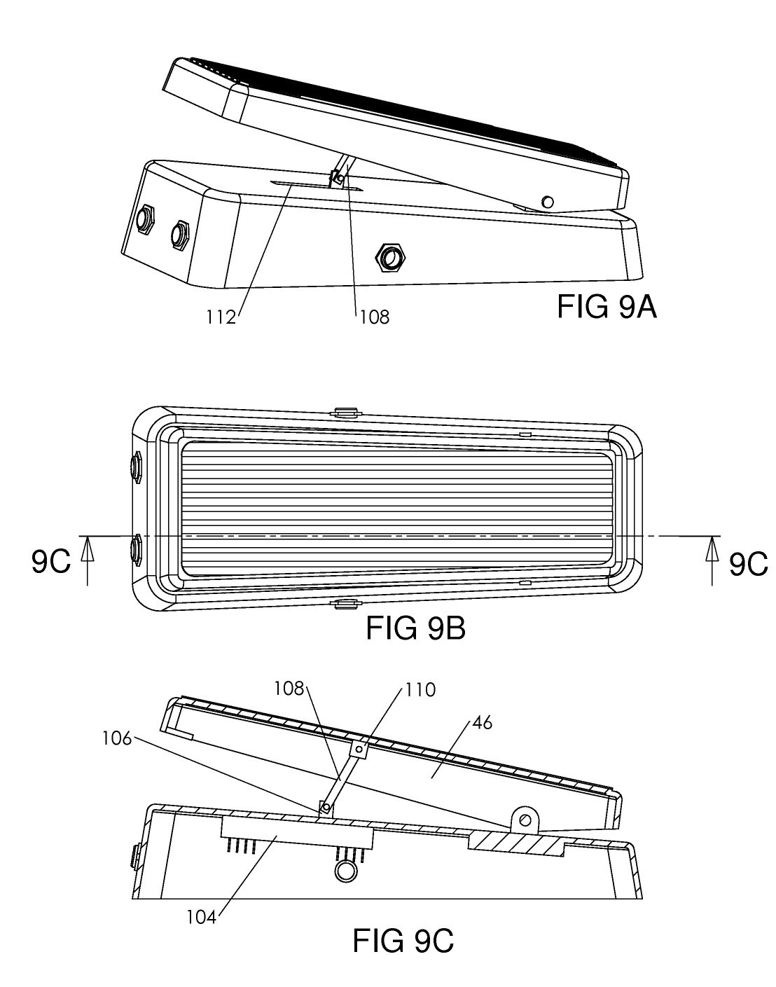

FIGS. 9A, 9B, and 9C show another alternative embodiment with a linear potentiometer.

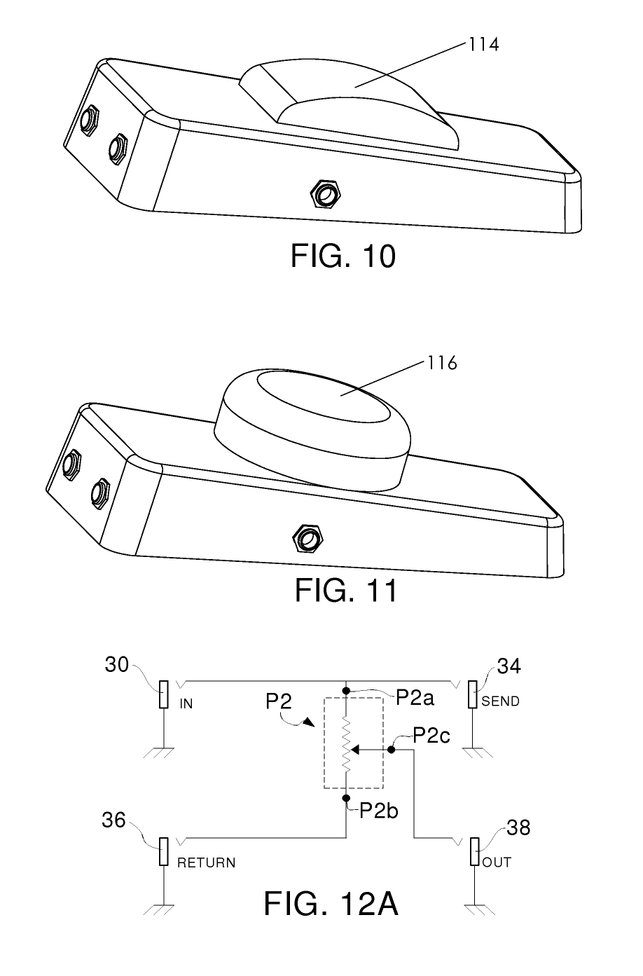

FIGS. 10, and 11 show other alternative embodiments

FIG. 12A shows a diagram of an alternative circuit using a simple potentiometer.

FIG. 12B shows a diagram of another alternative circuit using an inverting transformer stage.

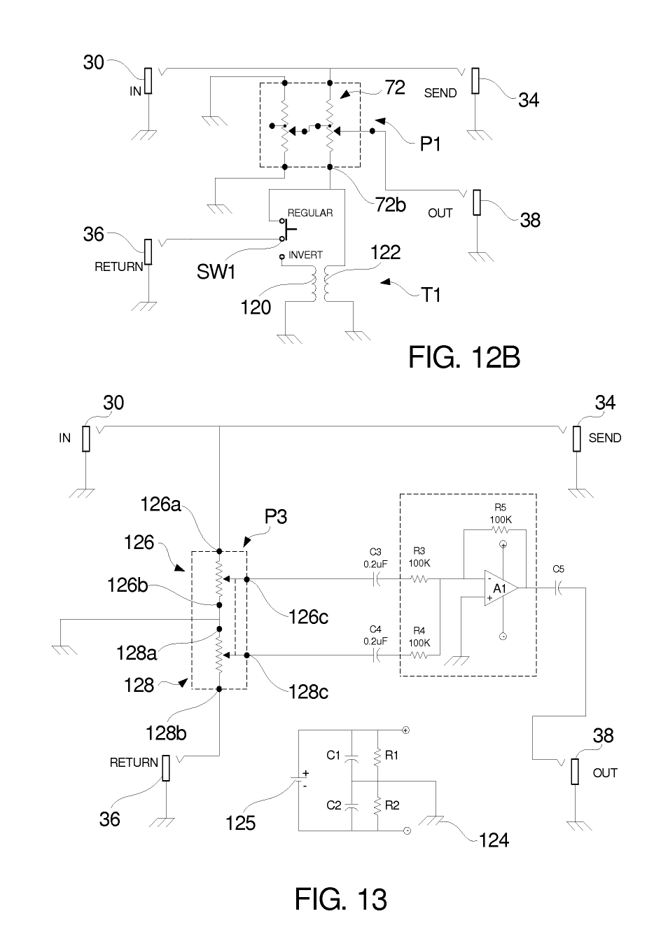

FIG. 13 shows a diagram of an alternative circuit using a variable resistance network and a combination circuit.

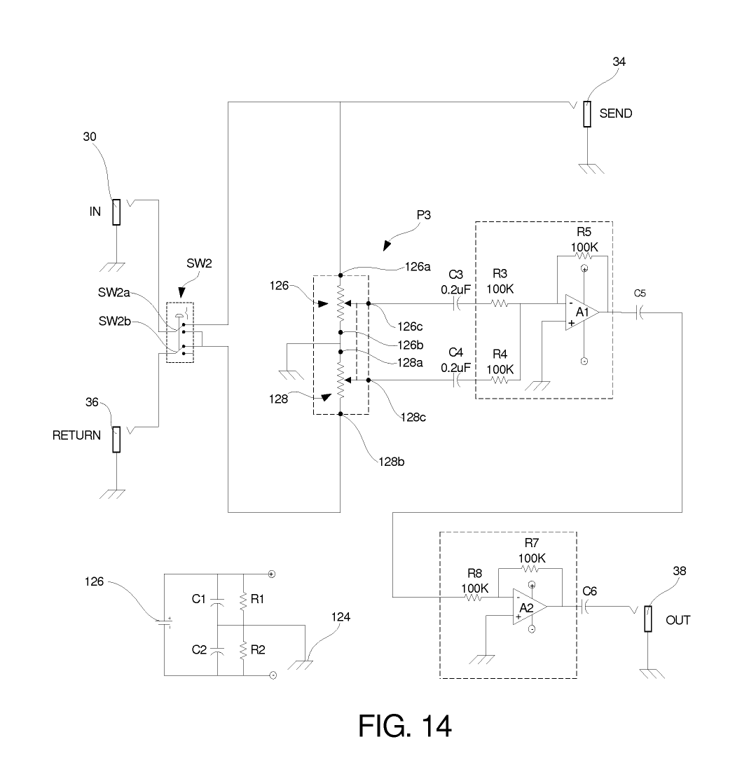

FIG. 14 shows a diagram of an alternative circuit using a volume mode switch.

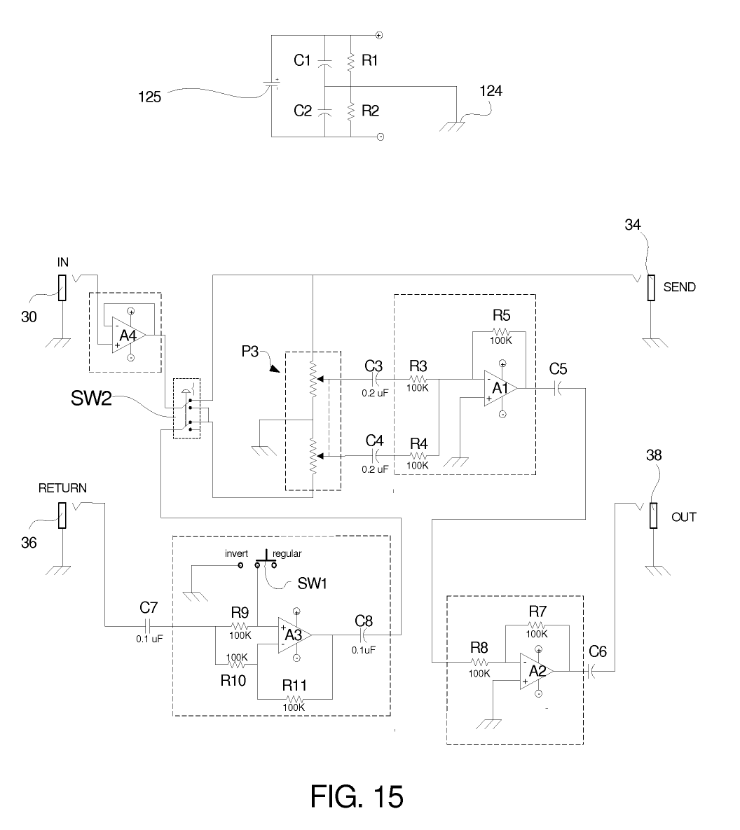

FIG. 15 shows a diagram of another alternative circuit using an inverting stage on the return signal

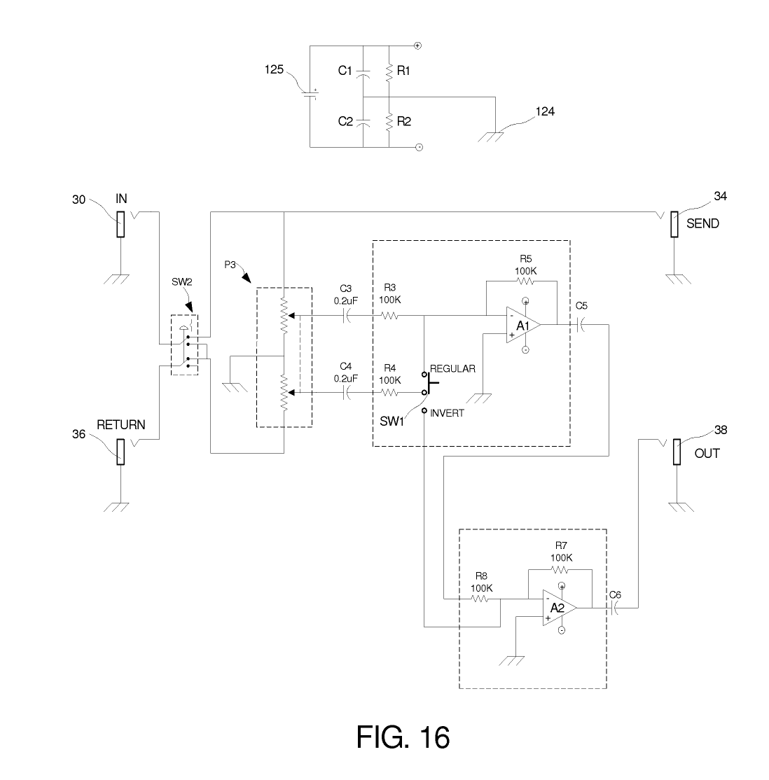

FIG. 16 shows a diagram of another alternative circuit using two operational amplifier stages.

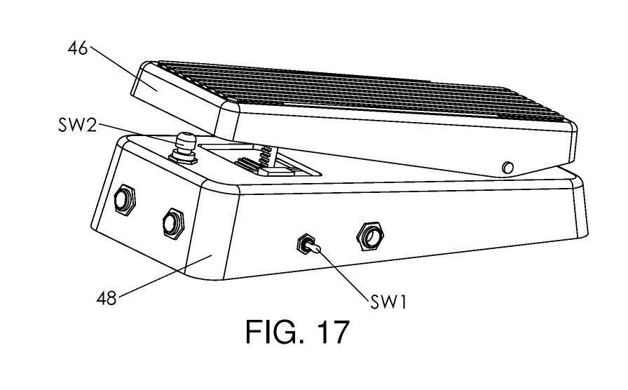

FIG. 17 shows a perspective view of an alternative embodiment of the pedal.

DRAWINGS-Reference numerals

| | |
|---|---|
| 30 input jack | 34 send jack |
| 30a main input jack | 34a first send jack |
| 32 mixing circuit | 34b second send jack |
| 34c third send jack | 70b second resistance |
| | connection |
| 36 return jack | 70c center tap connection |
| 36a first return jack | 70d wiper |
| 36b second return jack | 72 second single |
| | potentiometer |
| 36c third return jack | 72a first resistance |
| | connection |
| 38 output jack | 72b second resistance |
| | connection |
| 38a main output jack | 72c center tap connection |
| 40 first mixer input | 72d wiper |
| 42 second mixer input | 74 effect chain |
| 44 mixer output | 76 first independent |
| | audio signal |
| 46 foot treadle | 78 second independent |
| | audio signal |
| 46a first treadle | 80 first pedal |
| 46b second treadle | 82 second pedal |
| 46c third treadle | 84 third pedal |
| 47 rubber grip | 86 fourth pedal |
| 48 base | 88 fifth pedal |
| 50 pivot pin | 90 sixth pedal |
| 52 rack | 92 first effect chain |
| 54 opening | 94 second effect chain |
| 56 gear | 96 third effect chain |
| 58 spring | 100 arbitrary audio signal |
| 60 bracket | 104 linear potentiometer |
| 62 circuit board | 106 potentiometer |
| | wiper arm |
| 64 boss | 108 link arm |
| 66 rack pivot pin | 110 link arm pivot point |
| 68 rack pivot boss | 112 slot |
| 70 first single | 114 slider treadle |
| potentiometer | |
| 70a first resistance | 116 foot knob |
| connection | |
| 120 primary coil | A2 second operational |
| | amplifier stage |
| 122 secondary coil | A3 third operational |
| | amplifier stage |
| 124 signal ground | A4 fourth operational |
| | amplifier stage |
| 125 battery | R1 resistor |
| 126 first resistance | R2 resistor |
| 126a first terminal | R3 resistor |
| 126b second terminal | R4 resistor |
| 126c wiper | R5 resistor |
| 128 second resistance | R6 resistor |
| 128a first terminal | R7 resistor |
| 128b second terminal | R8 resistor |
| 128c wiper | R9 resistor |
| P1 center-tapped dual- | R10 resistor |
| gang potentiometer | |
| P2 single potentiometer | R11 resistor |
| P2a first terminal | Cl capacitor |
| P2b second terminal | C2 capacitor |
| P2c wiper terminal | C3 capacitor |
| P3 dual-gang | C4 capacitor |
| potentiometer | |
| SW1 single-pole | C5 capacitor |
| double-throw | |
| phase | |
| inversion switch | C6 capacitor |
| SW2 bistable dual- | C7 capacitor |
| pole dual- | |
| throw switch | |
| SW2a first contact | C8 capacitor |
| SW2b second contact | T1 phase inversion |
| A1 first operational | transformer |
| amplifier stage | |

### DETAILED DESCRIPTION

### First Embodiment

### FIGS. 1-3

### Block Diagram Description—FIG. 1

FIG. 1 shows a block diagram representation of a first embodiment of an audio effect control pedal. A first input connection or input jack 30 is connected to a first mixer input 40 of a mixing circuit 32. Jack 30 is also connected to a second output connection, or send jack 34. A second input connection, or return jack 36 is connected a second mixer input 42 of mixing circuit 32. A mixer output 44 of the mixing circuit is connected to a first output connection, or output jack 38. A transducer or foot treadle 46 commands the operation of mixing circuit 32.

### Mechanical Description—FIGS. 2A-2E

FIG. 2A is a perspective view of the first embodiment. A rubber grip 47 adheres to transducer, or foot treadle 46. The treadle is pivotally connected to a base 48 by a pivot pin 50 that engages a boss 64 (boss shown in FIG. 2E). Input jack 30 is mounted on the right side of base 48.

FIGS. 2B and 2C are perspective views of the left side and underside of the pedal. Output jack 38 is mounted to the left side of base 48. Send jack 34 and return jack 36 are mounted to the front face of the base. A rack 52 is pivotally connected to the underside of treadle 46 and passes through an opening 54 in base 48. Rack 52 engages gear 56 which is axially connected to a center-tapped dual-gang potentiometer P1. Potentiometer P1 is mounted to a bracket 60 that is fixed to the base. A spring 58 maintains the rack engaged with the gear. A circuit board 62 is connected to the underside of the base and is wired to the jacks as described below and shown in FIG. 3.

FIGS. 2D and 2E show a cross-sectional view of the pedal. Rack pivot boss 68 is part of the treadle. Boss 68 connects to the rack 52 by a rack pivot pin 66.

The pedal is about 200 millimeters long, 100 millimetres wide, and 80 millimeters high and can comfortably support the foot of a musician. The treadle and base are preferably made out of cast aluminum, but may be made out of another durable and strong material, like cast iron or a rigid plastic.

### Electrical Description—FIG. 3

FIG. 3 shows potentiometer P1. The potentiometer has a value of 500 kilo Ohms, but may have other values. Potentiometer P1 is made up of a first resistance, or first single potentiometer 70 and second resistance, or second single potentiometer 72. Potentiometer 70 has a first resistance terminal or connection 70a, a second resistance terminal or connection 70b, a center tap connection 70c, and a wiper 70d. Similarly, potentiometer 72 has a first resistance terminal or connection 72a, a second resistance terminal or connection 72b, a center tap connection 72c, and a wiper 72d. Since P1 is a dual-gang potentiometer, wipers 70d and 72d are mechanically linked and move together along their respective potentiometers. As wiper 70d moves closer to connection 70b, wiper 72d moves towards connection 72b at the same rate. Center taps 70c and 72c remain at a fixed position along the potentiometer such that the resistance value between the center tap and its respective resistance connection (70a or 72a) remains constant and is substantially half the value of the resistance from 70a to 70b or from 72a to 72b.

Input jack 30 is connected to send jack 34 and first resistance connection 72a on second potentiometer 72. Return jack 36 is connected to second resistance connection 72b on second potentiometer 72. Wiper 72d on second potentiometer 72 is connected to output jack 38. Center tap 72c on second potentiometer 72 is connected to wiper 70d on first potentiometer 70. Both first connection 70a and second connection 70b of first potentiometer 70 are connected to ground. Center tap connection 70c of potentiometer 70 is not connected.

### First Mode of Operation—Effect Control Configuration—FIGS. 2E, 3, and 4

As seen in FIG. 4, one connects a cable from an instrument to input jack 30 of the pedal, thus producing a first electrical signal. Output 38 is connected to an amplifier or other receiving unit (recording circuit, computer, etc). Send jack 34 is connected to the input of an effects chain 74. The output of the effect chain creates a second electrical signal connected to return jack 36. As seen in FIG. 2E, one can tilt treadle 46 forward and backward between a first and second position. This movement will force rack 52 to move up and down and therefore cause gear 56 to turn. This action changes the value of potentiometer P1. The potentiometer acts as a mixing circuit that creates an electrical output signal, or combination signal, that is output on jack 38. As the user tilts the treadle forward, wipers 70d and 72d move towards connections 70b and 72b, respectively. Therefore, as the treadle is rocked forward, the signal entering on return jack 36 becomes more dominant in the output signal. As the treadle is rocked back, the signal on input jack 30 becomes more dominant. Thus, one can rock the treadle to a certain position to control the relative proportions of the two signals on input jack 30 and return jack 36.

Potentiometer 70 serves to ground out the undesired signal as the pedal nears its extreme positions. When the pedal is rocked all the way back, wiper 72d is connected to the input jack, and wiper 70d is connected to ground. This creates a 250 kilo Ohm ground connection for the return signal through center tap 72c. This prevents the return signal from mixing with the input signal when the treadle is all the way back. A similar functionality applies when the treadle is rocked all the way forward—the input signal is grounded out and prevented from mixing with the return signal.

Typically, the signal on input jack 30 will be a clean, undistorted signal from an instrument. The signal entering jack 36 will typically come from an effects chain, which will have distorted or otherwise modified the original instrument signal. The user can therefore control the amount effect that is present in the final signal by tilting the treadle back and forth.

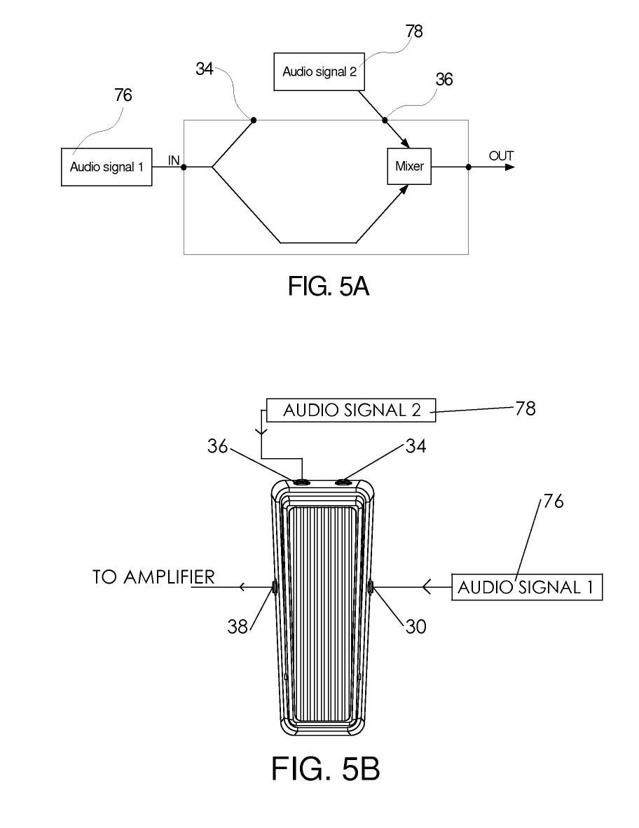

### Second Mode of Operation—Arbitrary Signal Mixing Configuration—FIGS. 5A and 5B

As seen in FIGS. 5A and 5B, return jack 36 need not be associated with the original signal nor the signal present on send jack 34. In this case, a first independent audio signal 76 and a second independent audio signal 78 are connected to jacks 30 and 36, respectively. The pedal then acts as a mixer: as the treadle is titled back, first signal 76 becomes more dominant on output 38, and as the pedal is tilted forward, second signal 78 becomes more dominant.

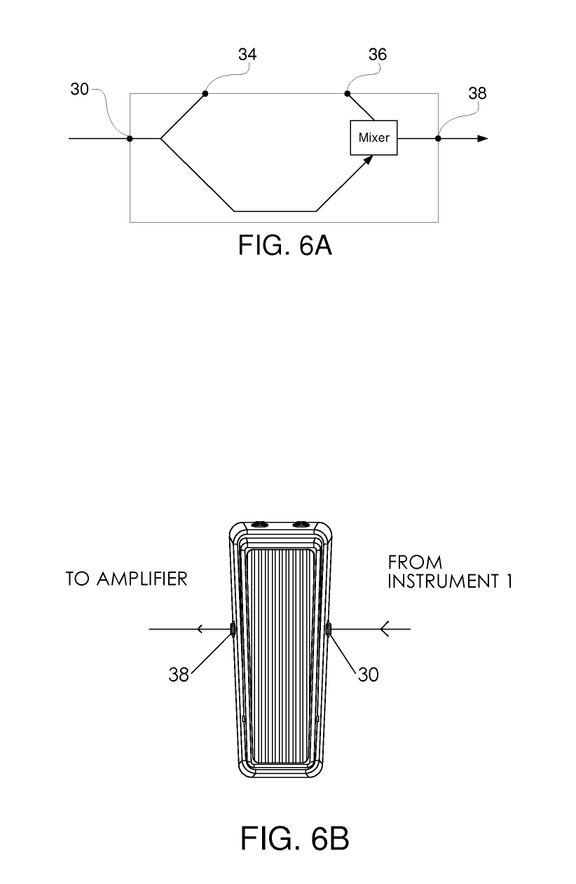

### Third Mode of Operation—Volume Pedal Configuration—FIGS. 6A and 6B

As seen in FIGS. 6A and 6B, if nothing is connected to return jack 36, the pedal will act as a volume pedal. As the treadle is rocked forward, the signal on input jack 30 is attenuated. This is because the signal from return jack 36 would typically become dominant as the pedal is rocked forward, but in this case, since there is no signal present on return jack 36, the signal on input jack 30 is simply attenuated.

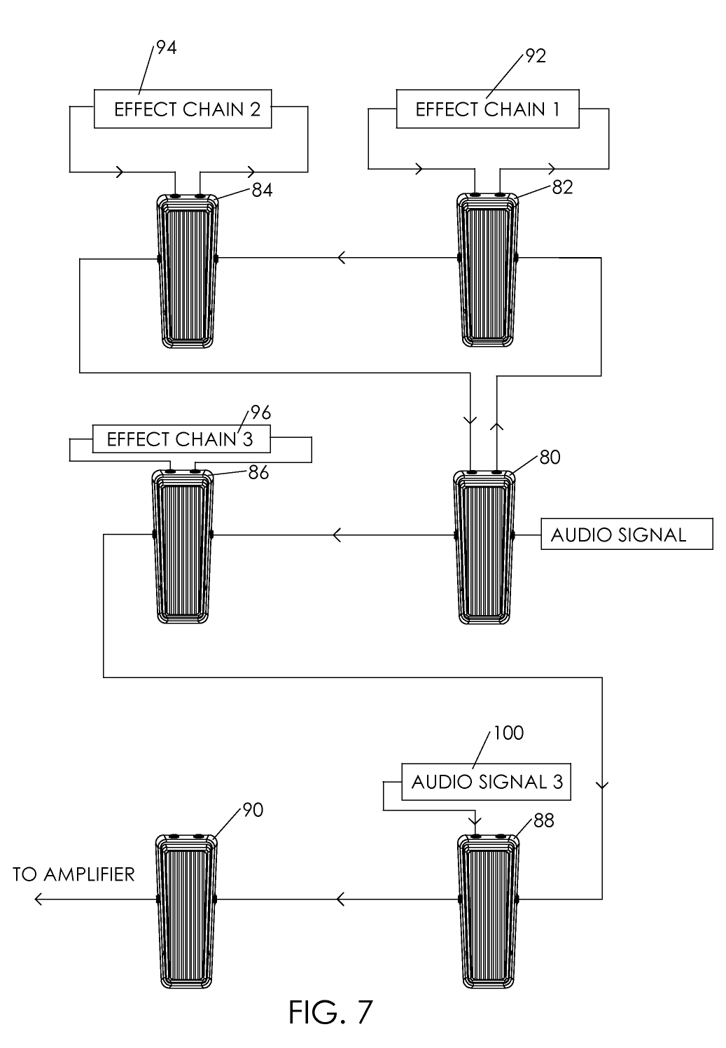

Fourth mode of operation—series and parallel configurations—FIG. 7

As shown in FIG. 7, several pedals can be used in an unlimited number of series and parallel connections. A first pedal 80, a second pedal 82, a third pedal 84, and a fourth pedal 86 are each connected in the first mode of operation, that of the effect control configuration. Second pedal 82 controls a first effect chain 92. Third pedal 84 controls a second effect chain 94. First effect pedal 80 controls the cumulative effect of effect chains 92, 94, and the effect control of pedals 82 and 84. Pedal 86 receives the resulting output from pedal 80 and mixes it with an effect chain 96 before passing the signal to a fifth pedal 88. Pedal 88 is in the second mode of operation, that of the arbitrary signal mixing configuration. Pedal 88 receives the signal from pedal 86 and mixes it with an arbitrary audio signal 100. The result is passed to a sixth pedal 90 which is in the third mode of operation, that of the volume pedal configuration. Pedal 90 controls the overall output volume. This configuration is an illustrative example—any number of pedals can be used in a variety of configurations.

### ALTERNATIVE EMBODIMENTS

### Alternative Embodiment

### Multi-Treadle Board—FIGS. 8A and 8B

FIGS. 8A and 8B show a multi-treadle board. Electrically, this board is the equivalent of cascading three single pedals: the output jack of the first pedal is connected to the input jack of the second, and the output jack of the second pedal is connected to the input jack of the third pedal. The main input is on the input of the first pedal and the main output is on the output of the third pedal. Three treadles, 46a, 46b, and 46c each have their respective send and return jacks: 34a and 36a; 34b and 36b; and 34c and 36c. A main input jack 30a receives the main signal. A main output jack 38a sends the final output signal to the amplifier. This configuration has the advantage of being able to independently control different parts of the effect chain. Although three treadles are shown, any number of treadles could be imagined.

### Alternative Embodiments

### Potentiometer Actuation—FIGS. 9A, 9B, 9C, 10, 11

FIGS. 9A to 9C show a linear potentiometer 104 instead of a rotary potentiometer. A link arm pivot point 110 is connected to the underside of treadle 46. A link arm 108 has one end pivotally connected to pivot point 110 and the other end pivotally connected to a potentiometer wiper arm 106. As the treadle is rocked back and forth, the link arm forces the wiper arm to move forward and backward, thus changing the resistance values. The electrical operation is the same as in the first embodiment.

In another embodiment, FIG. 10 shows a slider treadle 114 which is directly connected to a linear potentiometer (not shown), like the one shown in FIG. 9C. As the slider treadle is slid forward and backward, the resistance values of the potentiometer are changed.

In another embodiment, FIG. 11 shows a foot knob 116 is axially connect to a rotary potentiometer (not shown). The foot knob is cylindrical and about 100 millimeters in diameter although other shapes and dimensions are possible. As the foot knob is rotated, the value of the potentiometer is varied. These are only some of the possible linkages that are possible between the treadle and the potentiometer. It is also possible to replace the potentiometer with light-dependent resistors and have the treadle more or less block a light source (a light-emitting diode, for example) to change the value of the resistors.

### Alternative Embodiment

### Simple Potentiometer—FIG. 12A

Referring to FIG. 12A, the circuit can be realized with a single potentiometer P2. Potentiometer P2 has a first terminal P2a, a second terminal P2b, and a wiper terminal P2c. Input jack 30 is connected to first terminal P2a and to send jack 34. Wiper terminal P2c is connected to output jack 38. Second terminal P2b is connected to return jack 36. The operation of this embodiment is similar to previous embodiments.

### Alternative Embodiment

### Transformer Signal Inversion—FIG. 12B

The circuit shown in FIG. 12B is similar to that of FIG. 3 but with the added functionality of being able to selectively phase shift the signal on return jack 36 by 180 degrees. Certain effect pedals phase-shift the signal 180 degrees. Although such a phase shift would not affect the sound if the effect was connected directly to an amplifier, this phase shift would cause destructive interference if it were mixed with the original signal in my pedal. To avoid this, the signal present on the return jack can be inverted so that it is in phase with the input signal.

A single-pole double-throw phase inversion switch SW1 is used to select whether the return signal is inverted. A transformer T1 is used to invert the signal. Transformer T1 has a primary coil 120 and a secondary coil 122. The common terminal of switch SW1 is connected to return jack 36. One of the terminals of switch SW1 is connected to second resistance connection 72b of second potentiometer 72. The other terminal of switch SW1 is connected to one side of primary coil 120. The other side of coil 120 is grounded. One side of secondary coil 122 is connected to resistance connection 72b. The other side of coil 122 is grounded. In operation, switch SW1 either sends the return signal straight to the potentiometer P1 for immediate mixing, or it sends it through the transformer to be inverted before it is mixed with the original signal.

### Alternative Embodiment Description

### Active Circuit—FIG. 13

An active circuit, as shown in FIG. 13 may be used. A battery 125 is used as a power source. Power may also come from a power adapter which is common in pedal construction. A resistor R1 is connected to the positive supply of battery 125. A resistor R2 is connected to the negative supply of battery 125. The other ends of resistors R1 and R2 are tied together and form an artificial ground 124. Resistors R1 and R2 are chosen to be the same value so that the artificial ground has a voltage value that is half that of the battery. This type of is artificial ground is necessary in such circuits where dual supply operational amplifiers are used. Alternatively, single-supply operational amplifiers could be used. A capacitor C1 is connected in parallel to resistor R1. A capacitor C2 is connected in parallel with resistor R2. Capacitors C1 and C2 serve to smoothen out the power supply.

A dual-gang potentiometer P3 has a first resistance or potentiometer 126 and a second resistance or potentiometer 128. Potentiometer 126 has a first connection 126a, a second connection 126b, and a wiper, 126c. Potentiometer 128 has a first connection 128a, a second connection 128b, and a wiper 128c. Potentiometer P3 being a dual-gang potentiometer, wipers 126c and 128c are linked together: as wiper 126c moves in one direction, so does wiper 128c.

Input jack 30 is connected directly to output jack 34 as well as being connected to connection 126a. Return jack 36 is connected to connection 128b. Connection points 126b and 128a are both connected to ground.

An operational amplifier A1 is provided and connected to the positive and negative supply of battery 125. Resistors R3, R4, and R5 are connected to amplifier A1 in a summing configuration. Thus, operational amplifier A1 serves to sum the signals that are present on the inputs of resistors R3 and R4. This summing configuration also inverts its output signal.

Resistor R3 is connected to wiper 126c via a coupling capacitor C3. Coupling capacitors allows alternative current signals to pass through while blocking direct current signals. Resistor R4 is connected to wiper 128c via a coupling capacitor C4. Thus, the output signal of operational amplifier A1 will be the inverted sum of the signals on wipers 126c and 128c. The output of operational amplifier A1 is tied to output jack 38 via coupling capacitor C5.

### Alternative Embodiment Operation

### Active Circuit—FIG. 13

Referring to FIG. 13, potentiometer P3 acts as a variable resistance network that proportionately varies the amplitude of the input and return signals. When wiper 126c is at connection point 126a, the signal on the wiper equals the signal on input jack 30. As the wiper is moved away from connection 126a, the signal on the wiper is reduced until it reaches zero when the wiper is grounded at connection 126b. Potentiometer 128 works in a similar way, but is wired to work in reverse: as wiper 126c moves toward connection point 128b, the signal on the wiper grows to match the amplitude of the signal return jack 36. Because of this inverted operation, and since the two wipers are tied together, wiper 126c sees its signal grow as wiper 128c sees its signal diminish, and vice versa.

When the treadle is completely rocked back, the signal on wiper 126c is equal to the signal on input jack 30 and the signal on wiper 128c is at ground. The signal on output jack 38 is therefore the same, although inverted, as the signal on input jack 30.

When the treadle is rocked forward half-way, the wiper signals are at half their full scale amplitude. The signal on output jack 38 is therefore a mix of the signals on the input jack and the return jack.

When the treadle is rocked all the way forward, the signal on wiper 128c is at full scale and the signal on 126c is at ground. The signal on output jack 38 is therefore the same as the signal on the return jack, although inverted.

The wiper signals vary smoothly between these different values as the treadle is changed positions. As the treadle is rocked forward, the signal on wiper 126c decreases while the signal on wiper 128c increases. These signals are passed to amplifier stage A1 which acts as a combination circuit, or summing circuit, to combine the two signals. It should be noted that the inversion (or the phase-shifting of 180 degrees) of the signal by the amplifier A1 has no influence on the audio qualities of the final amplified signal.

### Alternative Embodiment

### Volume Switch and Final Inversion Stage—FIG. 14

In FIG. 14, a bistable dual-pole dual throw switch, or volume mode switch, SW2 is provided that has a first contact SW2a and a second contact SW2b. Each contact has a common terminal, a normally closed terminal, and a normally open terminal. Switch SW2 is connected between jack 30, jack 36, and the rest of the circuit. Input jack 30 is connected to the common terminal of contact SW2a. The normally closed terminal of contact SW2a is connected to the rest of the circuit as input jack 30 is in the previous FIG. 13. The normally open terminal of contact SW2a is connected to the normally closed terminal of contact SW2b. The normally closed terminal of terminal SW2b is also connected to the rest of the circuit as return jack 36 was in the previous FIG. 13. The normally open terminal of contact SW2b is not connected.

In operation, the role of switch SW2 is to make the pedal act as a volume pedal: the input signal is attenuated when the treadle is back, and the input signal becomes stronger as the treadle is rocked forward. Furthermore, when used as a volume pedal, the return signal is not taken into account. When switch SW2 is not activated, its contacts are as shown in FIG. 14 and the pedal operation is the same as described in FIG. 13: the input signal is mixed with the return signal. However, when SW2 is activated, the return signal is cut off and the input signal gets routed to the opposite side of potentiometer P3. The return signal is therefore not mixed with the input signal and the pedal acts like a standard volume pedal—the input signal becomes more dominant as the treadle is rocked forward and is attenuated as the treadle is rocked backward.

With respect to FIG. 13, FIG. 14 also shows the addition of an operational amplifier A2, a resistor R7, and a resistor R8 which form a final inverting stage with unity gain to re-invert the final output signal so that it is in phase with the original input signal. Capacitor C6 is coupling capacitor that ties amplifier A2 to the output jack.

### Alternative Embodiment

### Inversion of Return Signal and Input Buffer—FIG. 15 and FIG. 17

In FIG. 15, an additional amplifying stage is provided by an operational amplifier A3 and resistors R9, R10, and R11. Switch SW1 selectively grounds the positive input of amplifier A3. When the positive input of amplifier A3 is grounded, amplifier A3 acts as an inverting circuit with unity gain. When the positive input of amplifier A3 is not grounded, amplifier A3 is a non-inverting unity gain buffer. Coupling capacitors C7 and C8 are used to wire amplifier A3 between return jack 36 and switch SW2. This selective inversion of the return signal is useful when the effect chain provides a signal that is inverted in relation to the input signal. This is the case with certain models of effect pedals.

Additionally, FIG. 15 shows the addition of an operational amplifier A4 which is wired in a buffer configuration. This amplifier has the effect of reducing any loading effects that the pedal circuit would have on the input signal and serves to power the signal sent out on send jack 34.

FIG. 17 shows the physical mounting of switch SW1 on the side of base 48 and switch SW2 mounted on the upper surface of base 48, under treadle 46. To activate switch SW2, one rocks treadle 46 forward until it pushes on switch SW2. These switches can be mounted in several different positions: on the underside, on the back, front etc. They may also be of different types, push button, toggle, rotary, push-push, etc.

### Alternative Embodiment

### Phase Matching—FIG. 16

FIG. 16 shows switch SW1 wired between amplifier stage A1 and second stage A2. The common terminal of switch SW1 is connected to resistor R4. One of the remaining terminals of switch SW1, a first terminal, is connected to the negative input of amplifier A1. The other terminal of switch SW1, a second terminal, is connected to the negative input of amplifier A2. Each amplifier stage has a first and second configuration, the choice of which is made by the position of switch SW1. When switch SW1 is in its first position as shown in FIG. 16, the circuit operation is the same as described for FIG. 14: amplifier A1 acts as a summing inverting amplifier to mix the signals, and amplifier A2 acts as an inverting amplifier to undo the inversion caused by amplifier A1. However, in the case where the return signal is inverted in relation to the input signal, switch SW1 can be switched to its second position. This has the effect of changing the wiring topology of the amplifiers: amplifier A1 takes on an inverting configuration and inverts the input signal so that it becomes in phase with the return signal, and amplifier A2 takes on the summing inverting configuration that mixes the signals. Thus, the input and return signals are in phase with each other at the time of summing to avoid any out-of-phase cancellation.

### Advantages

From the description above, a number of advantages of some embodiments of my audio effect control pedal become evident:
(a) Without using their hands, users are able to modify the amount of effect that is present from an external effect chain. This allows users to change the sound while they continue playing with their instrument.
(b) The pedal can be used with any external effect or sound source; it is not limited to a finite number of built-in effects.
(c) The pedal can mix two arbitrary audio signals, such as guitar and piano for example.
(d) The pedal can be selectively used in volume mode, whereby the effect chain is muted and the pedal increases the volume of the input signal as the treadle is rocked forward.
(e) Inverted signals coming from external effect chains can be re-inverted by the pedal before mixing with the input signal, thus avoiding out-of-phase cancellation.
(f) Several pedals can be used in series or parallel configurations to have control over different subgroups of an effect chain.

### CONCLUSIONS, RAMIFICATIONS, AND SCOPE

Accordingly, the reader will see that the audio effect control pedal of the various embodiments can be used to control the amount of effect that is present from an external effect device. This control is done without the user's hands, thereby allowing the user to modify the sound as they continue playing their instrument. In addition, the pedal can mix two independent sound sources or act as a standard volume pedal. Furthermore, the pedal has the additional advantages in that:
It avoids the use of complex and expensive microprocessor circuitry
It uses standard parts and methods of construction that are well known in the art
Instead of abruptly switching an effect chain ON or OFF, musicians can smoothly fade in or fade out their effect chains
More than simply providing a smooth transition from OFF to ON, the pedal can be rocked to different positions at various times during a song in a way that adds to the musical rhythm, sound, or quality.

Although the description above contains many specificities, these should not be construed as limiting the scope of the embodiments but as merely providing illustrations of some of several embodiments. For example, the pedal can have other shapes such as round or oval, the jacks and selection switches can be positioned at different locations, the resistors can have different values, different circuit subgroups in some embodiments can be selectively discarded or used with circuit subgroups from other embodiments, other electronic parts can be used instead of operational amplifiers, such as vacuum tubes. The actuation of the potentiometer can be done with a cable and a pulley instead of a rack and gear. Many different configurations of parts are possible. Thus the scope of the embodiments should be determined by the appended claims and their legal equivalents, rather than by the examples given.

I claim:

1. An audio signal control device, comprising:
(a) a first input connection for receiving a first electrical signal;
(b) a second input connection for receiving a second electrical signal;
(c) a first output connection for sending an electrical output signal;
(d) a mixing circuit for creating a combination signal of proportions of first and second signals, said mixing circuit having a first input, a second input, and an output, said first connection connected to said first input of said mixer, said second connection being connected to said second input of said mixer, and said output connection connected to said output of said mixer, and
(e) a transducer having a first and a second position and positioned between said first position and said second position, said transducer arranged to modify a circuit parameter of said mixing circuit so as to vary the relative proportion of said first and second electrical signals in the output signal;
whereby a person may vary the position of said transducer to change the proportion of first and second signals present in the output signal.

2. The control device of claim 1, further including a second output connection connected to said first input connection.

3. The control device of claim 1, further including a volume mode switch that disconnects said second electrical signal and reroutes said first electrical signal to said second input of said mixer circuit, whereby said switch cuts out the presence of said second signal and causes amplitude of said first electrical signal to increase as said transducer is moved from said first position to said second position.

4. The control device of claim 1, further including an inversion circuit that can be selectively activated, such that said second electrical signal is inverted.

5. The device of claim 4 wherein said inversion circuit is an operational amplifier in an inverting configuration with a gain substantially near unity.

6. The device of claim 1 wherein said mixing circuit is a potentiometer having a first terminal, a second terminal, and a wiper terminal, said first terminal being connected to said first connection, said second terminal being connected to said second connection, said wiper being connected to said output connection, said transducer being a treadle and said treadle having a mechanical linkage to said potentiometer.

7. The device of claim 1 wherein said mixing circuit comprises a dual-gang potentiometer, said dual-gang potentiometer having a first resistance and a second resistance, said first resistance having a first terminal at one end, a second terminal at the opposite end, a wiper that slides along said first resistance from said first terminal to said second terminal, and a center tap connection that remains fixed at substantially the middle of said first resistance, said second resistance having a first terminal at one end, a second terminal at the opposite end, a wiper that slides along said second resistance from said first terminal to said second terminal, said first terminal of said first resistance being connected to said first connection, said second terminal of said first resistance being connected to said second connection, said wiper of said first resistance being connected to said output connection, said center tap of said first resistance being connected to said wiper of said second resistance, said first terminal and said second terminal of said second resistance being connected to ground.

8. The device of claim 1 wherein said mixing circuit comprises a variable resistance network and a combination circuit, said variable resistance network having a first input connected to said first connection, a second input connected to said second connection, a first output connected to said combination circuit, and a second output connected to said combination circuit, wherein said first output produces an attenuated version of said first electrical signal, said second output produces an attenuated version of said second electrical signal, the attenuation of the two signals being inversely related.

9. The device of claim 8 wherein said combination circuit is an operational amplifier used in a summing-inverting configuration.

10. The device of claim 8 wherein said combination circuit comprises a single-pole dual-throw switch, a first operational amplifier stage, and a second operational amplifier stage, the switch having a regular position, an inverting position, a first terminal, a second terminal, and a common terminal, said regular position of the switch being the position wherein continuity exists between said first terminal and said common terminal, said inverting position of the switch being the position wherein continuity exists between said common terminal and said second terminal, said first operational amplifier stage having a first and second configuration, said first configuration of said first operational amplifier stage being a summing-inverting configuration, said second configuration of said first operational amplifier stage being an inverting configuration, said second operational amplifier stage having a first and second configuration, said first configuration of said second operational amplifier stage being an inverting configuration, said second configuration of said second operational amplifier stage being a summing-inverting configuration, the common terminal of the switch being connected to said first output of said variable resistance network, said first terminal and said second terminal of the switch connected to said first and second operational amplifier stages such that when the switch is in said regular position, the amplifier stages are in their respective first configurations, and when the switch is in said inverting position, the amplifier stages are in their respective second configurations, whereby said first electrical signal can be selectively inverted to match phase with said second electrical signal before the signals are summed together, thus avoiding out-of-phase cancellation.

11. The device of claim 8 wherein said variable resistance network is a plurality of light-emitting diodes and light-dependent resistors, wherein the movement of said transducer variably blocks light from light-emitting diodes from reaching light-dependent resistors.

12. The device of claim 8 wherein said variable resistance network is a dual-gang potentiometer, said transducer is a treadle, the potentiometer having a mechanical linkage to said treadle, said dual-gang potentiometer having a first resistance and a second resistance, said first resistance having a first terminal at one end, a second terminal at the opposite end, a first wiper that slides along said first resistance from said first terminal to said second terminal, said second resistance having a first terminal at one end, a second terminal at the opposite end, and a second wiper that slides along said second resistance from said first terminal to said second terminal, said wipers of said first and second resistances being mechanically linked such that the position of said first wiper along said first resistance is equivalent to the position of said second wiper along said second resistance, said first terminal of said first resistance being connected to said first input connection, said second terminal of said second resistance being connected to said second input connection, said second terminal of first resistance being connected to ground, and said first terminal of said second resistance being connected to ground, said wipers of said first resistance and said second resistance each being connected to said combination circuit.

13. The device of claim 12 wherein the potentiometer is a rotary potentiometer and said mechanical linkage is made up of a rack mounted in a substantially perpendicular fashion to the underside of said treadle, said rack engaging a gear connected to the potentiometer.

14. The device of claim 12, further comprising a pulley and wherein the potentiometer is a rotary potentiometer, and wherein said mechanical linkage is a cable that is attached near the front and rear underside of said treadle, said cable engaging said pulley connected to the potentiometer.

15. The device of claim 12 wherein said potentiometer is a linear potentiometer and said mechanical linkage is a link arm pivotally connected to the underside of said treadle and pivotally connected to said wipers of the potentiometer.

16. An audio signal control device, comprising:
(a) a first terminal for receiving a first electrical signal;
(b) a second terminal for receiving a second electrical signal;
(c) an output connection for sending an electrical output signal;
(d) a transducer and means for producing said electrical output signal as a mix of the first and second signals, said transducer being connected to said means for producing said electrical output, said mix having inversely related proportions of said first and second electrical signals, said inversely related proportions corresponding to position of said transducer;
whereby a person may vary the position of said transducer to change the proportion of first and second signals present in the output signal.

17. The control device of claim 16, further including a volume mode switch and means for disconnecting said second electrical signal and inverting proportion of said first electrical signal relative to position of said transducer.

18. The control device of claim 16 wherein said means for producing said electrical output comprises a variable resistance network and a summing circuit, said variable resistance network producing attenuated versions of said first and second electrical signals, said attenuated versions inversely related to one another.

19. The control device of claim 16 wherein said variable resistance network is a dual-gang potentiometer.

20. A method of varying the mixing proportion of two electrical signals, comprising:
(a) providing an effect control circuit of the type comprising a first input connection, a second input connection, an output connection, a mixing circuit for producing a combination signal of input signals present on said first and second input connections and sending said combination signal to said output connection, the proportions of the input signals in said combination signal being inversely related, a treadle whose position varies the setting of a variable resistance component that is part of said mixing circuit so as to vary proportions of signals in said combination signal,
(b) providing a first electrical audio source and connecting said first input connection to said first electrical audio source,
(c) providing a second electrical audio source and connecting said second input connection to said second electrical audio source, and
(d) providing an audio amplifier and connecting said output connection to said audio amplifier for transforming said combination signal into audible sound,
whereby a user can vary the proportions of the first and second sources that are present in said combination signal without the use of their hands.
